(19) United States
(12) Patent Application Publication
(10) Pub. No.: US 2010/0314917 A1
(43) Pub. Date: Dec. 16, 2010

(54) Saddle Adjusting Device

(76) Inventor: Shu-Erh HSIEH, Taichung City (TW)

Correspondence Address: Dr. BANGER SHIA;Patent Office of Bang Shia, 102 Lindencrest Ct., Sugar Land, TX, 77479-5201, US

(21) Appl. No.: 12/688,882

(22) Filed: Jan. 16, 2010

(30) Foreign Application Priority Data
Jun. 16, 2009 (TW) 098210735

(51) Int. Cl. B62J 1/08

(52) U.S. Cl. 297/215.13

(57) ABSTRACT

A saddle adjusting device is slidably disposed on a seat tube and comprises a seat body. The seat body is provided on a top end thereof with a saddle and includes a through portion for insertion of the seat tube. The seat body is provided with at least one seat tube clamp for clamping the seat body on the seat tube and further provided in a middle portion of the through portion with a hollow portion laterally penetrating the seat body and plural engaging grooves. The seat tube is fixedly provided with a bolt for cooperating with the engaging assembly. The engaging assembly can move along the bolt in a direction vertical to the axial direction of the seat tube to make protruding portions of the engaging assembly engage into or disengage from the engaging grooves for adjusting the position of the seat body relative to the seat tube.

### BACKGROUND OF THE INVENTION

1. Field of the Invention

The present invention relates to a saddle adjusting technology, and more particularly to a saddle adjusting device for a folding bicycle which can offer a multi-height adjusting and assuredly-fixing function.

2. Description of the Prior Art

Common bicycle saddles are all disposed on a top end of a seat post which is inserted into a bicycle frame, and the bicycle frame is provided with a seat post clamp for clamping the seat post to fix the seat post.

When the height of the saddle needs adjusting, the seat post clamp should unclamp the seat post first, and then the height of the seat post which protrudes out of the bicycle frame can be adjusted, and finally after the saddle is adjusted to a desired height, the seat post clamp will clamp the seat post again to fix the seat post on the bicycle frame.

However, the existing bicycle frames have various styles, and it is particularly so for the folding bicycles, because the folding bicycles must consider the volume after being folded so as to facilitate the carrying, therefore, there are many different forms of frames.

Referring to FIG. 1, a conventional triangular bicycle frame 8 essentially comprises a front post 81, a seat post 82 and a bottom post 83 that are pivotally connected to one another. The top end of the seat post 82 is pivotally connected to the top end of the front post 81, and the bottom end of the seat post 82 is pivotally connected to a rear wheel 84 and a rear end of the bottom post 83 while the front end of the bottom post 83 is fastened on a fastening seat 811 on a lower portion of the front post 81. The bottom end of the front post 81 is connected with a front fork 812 to be pivoted to the front wheel 85. The top end of the front post 81 is provided with a handlebar 86, and the middle portion of the bottom post 83 is provided with a chain ring 87 having a pair of cranks 88 and a pair of pedals 881. The chain ring 87 is drivingly connected to a smaller chain ring 89 disposed on the rear wheel 84 through a belt 871. The seat post 82 is further provided with a saddle mechanism 9. By such arrangements, a folding bicycle is formed.

The saddle mechanism 9 includes a seat body 91 which is slightly L-shaped and slidably engaged on the seat post 82. The top end of the seat body 91 is provided with a saddle 92.

When no external force is applied between the seat body 91 and the seat post 82, the seat body 91 and the seat post 82 are in loose fit state. The seat body 91 is provided with two seat post clamps 93 for clamping the seat body 91 on the seat post 82. The seat post 82 is provided with a bolt 94 having one end protruded out of the seat post 82, and the seat body 91 is defined with plural engaging grooves 95 correspondingly to the bolt 94. When the two seat post clamps 93 are loosensed, the respective engaging grooves 95 will form clearances for insertion of the bolt 94, and when the two seat post clamps 93 are tightened, the engaging grooves 95 will be forced to clamp the bolt 94 fixedly.

In other words, the saddle mechanism 9 can be positioned at a desired position through the cooperation of the bolt 94 with the engaging grooves 95, and the seat body 91 is clamped on the seat post 82 by the two seat post clamps 93, thus realizing the position adjustment and fixing of the seat body 91.

Nevertheless, considering the lightness and the cost of the saddle mechanism 9, the above seat body 91 is made of engineering plastic, but the engineering plastic is still not rigid enough even it has a high strength, so that when the seat body 91 is clamped on the seat post 82 by the seat post clamps 93, the engineering-plastic-made seat body 91 itself will be compressed to cause elastic deformation. Therefore, the resulting clamping force is less than the clamping force applied by the conventional metal frame to the metal seat post, that is to say, when the seat body 91 bears the weight of the rider, the seat body 91 clamped by the two seat body clamps 93 will still slip slightly.

Commonly, a clearance difference between a loosened seat post clamp and a tightened seat post clamp is only about 1 to 2 mm, but the changing of the clearance must allow the engaging grooves 95 to define a clearance therebetween for passage of the bolt 94, so that the engaging portion of the engaging groove 95 for the bolt 94 only has a depth of 1-2 mm. Further since the bolt 94 is cylinder-shaped, the contact area between the engaging groove 95 and the bolt 94 is quite limited, and since the seat body 91 is made of the engineering plastic, when the seat body 91 bears the weight of the rider and slides relative to the seat post 82, the bolt 94 will be forced to disengage from the engaging groove 95, thus defeating the positioning effect. If such a situation occurs frequently, the engaging groove 95 will be damaged to cause permanent deformation, thus losing the positioning effect.

The present invention has arisen to mitigate and/or obviate the afore-described disadvantages.

### SUMMARY OF THE INVENTION

The primary objective of the present invention is to provide a saddle adjusting device which is provided with an engaging assembly capable of moving in a direction vertical to the axial direction of the seat tube and position the seat body on the seat tube by engaging the protruding portions of the engaging assembly into the engaging grooves of the seat body and use the seat tube clamp to clamp the seat body on the seat tube so as to offer a multi-height adjustment and assuredly-fixing function.

The secondary objective of the present invention is to provide a saddle adjusting device which is provided on the seat body with a penetrating portion corresponding to the seat tube clamp, at the penetrating portion are formed two half rings, and the seat tube clamp can be used to assuredly fix the two half rings.

The third objective of the present invention is to provide a saddle adjusting device which can position the seat tube clamp during assembling process by providing two ears at both sides of the penetrating portion correspondingly to the pin of the seat tube clamp and defining an engaging hoe in each of the ears for insertion of the pin.

In order to achieve the above objectives, a saddle adjusting device in accordance with the present invention is slidably disposed on a seat tube and comprises a seat body, the seat body includes a support portion on a top end thereof for placement of a saddle, the seat body is provided with a through portion for insertion of the seat tube, and at least one seat tube clamp along the through portion for clamping the seat body on the seat tube. The seat body is provided in a middle portion of the through portion with a hollow portion which laterally penetrates the seat body, and the hollow portion is defined at one side thereof with plural engaging grooves along the seat tube. The seat tube is fixedly provided with a bolt and provided with an engaging assembly for cooperating with the bolt, and the engaging assembly is allowed to move along the bolt in a direction vertical to an axial direction of the seat tube. The engaging assembly is formed with at least one protruding portion at one side thereof adjacent to the respective engaging grooves for engaging into the engaging grooves.

By such arrangements, the engaging assembly can move in the direction vertical to the axial direction of the seat tube to make the protruding portions of the engaging assembly engage into or disengage from engaging grooves for adjusting the position of the seat body relative to the seat tube, and the seat tube clamp is used to clamp the seat body on the seat tube to offer the assuredly-fixing function.

Preferably, the seat body includes a penetrating portion corresponding to the seat tube clamp, and the seat body is provided with two half rings to form a part of the through portion at the penetrating portion, so that the seat tube clamp can tighten or loosen the two half rings to offer the assuredly-fixing function.

Preferably, the seat body is provided with two ears at both sides of the penetrating portion correspondingly to the pin of the seat tube clamp, and each of the ears is defined with an engaging hole for engagement with the corresponding pin, so that the seat tube clamp can be positioned on the seat body during the assembling process for facilitating assembly, and the seat tube clamp which has been installed can be located at an assured position to offer the assured function.

### BRIEF DESCRIPTION OF THE DRAWINGS

FIG. 1 is a schematic view of a conventional triangular bicycle frame;

FIG. 2 is a plane view of a saddle adjusting device in accordance with the present invention;

FIG. 3 is a perspective view of a seat body for the saddle adjusting device in accordance with the present invention;

FIG. 4 is a cross-sectional view of the saddle adjusting device in accordance with the present invention along the line 4-4 of FIG. 2;

FIG. 5 is a cross-sectional view of the saddle adjusting device in accordance with the present invention along the line 5-5 of FIG. 2;

FIG. 6 is a cross-sectional view of an engaging assembly of the saddle adjusting device in accordance with the present invention; and

FIG. 7 is an operational view of the engaging assembly of the saddle adjusting device in accordance with the present invention.

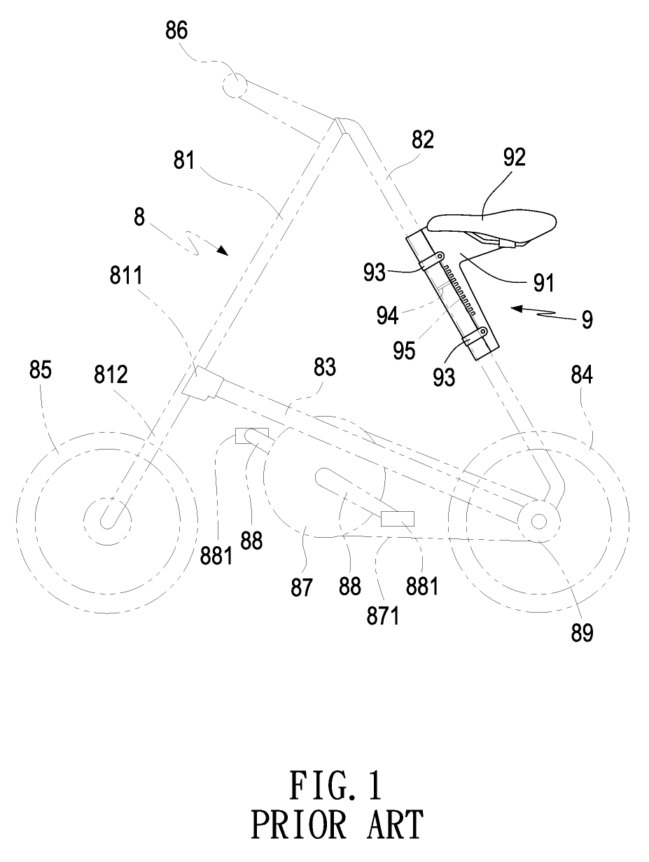

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

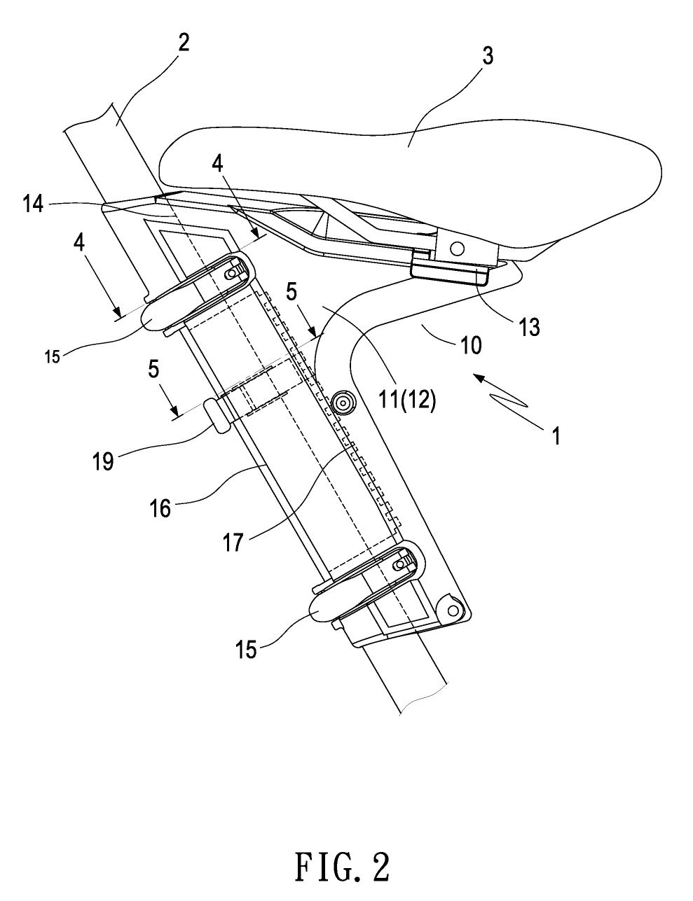

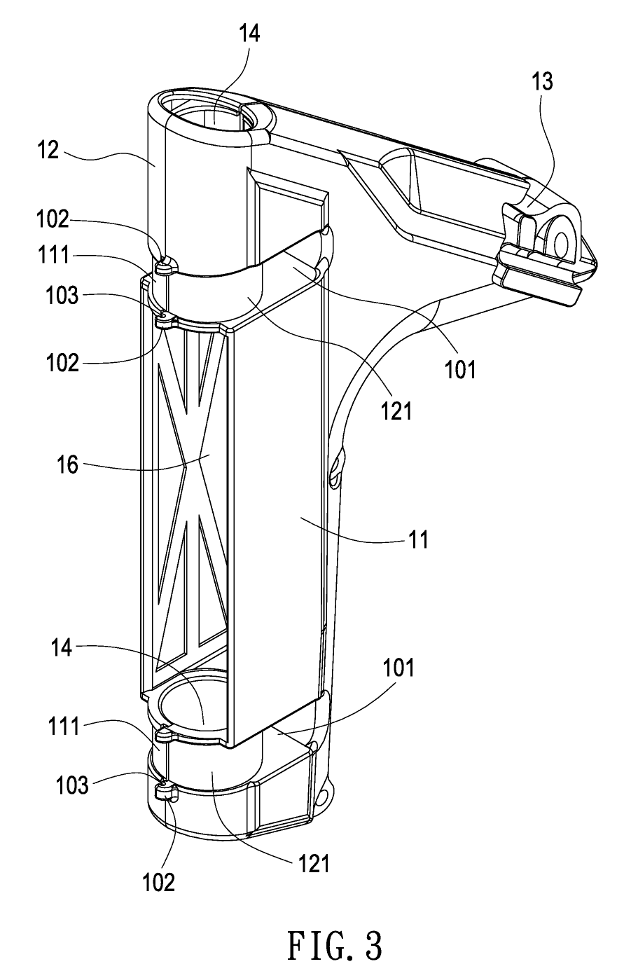

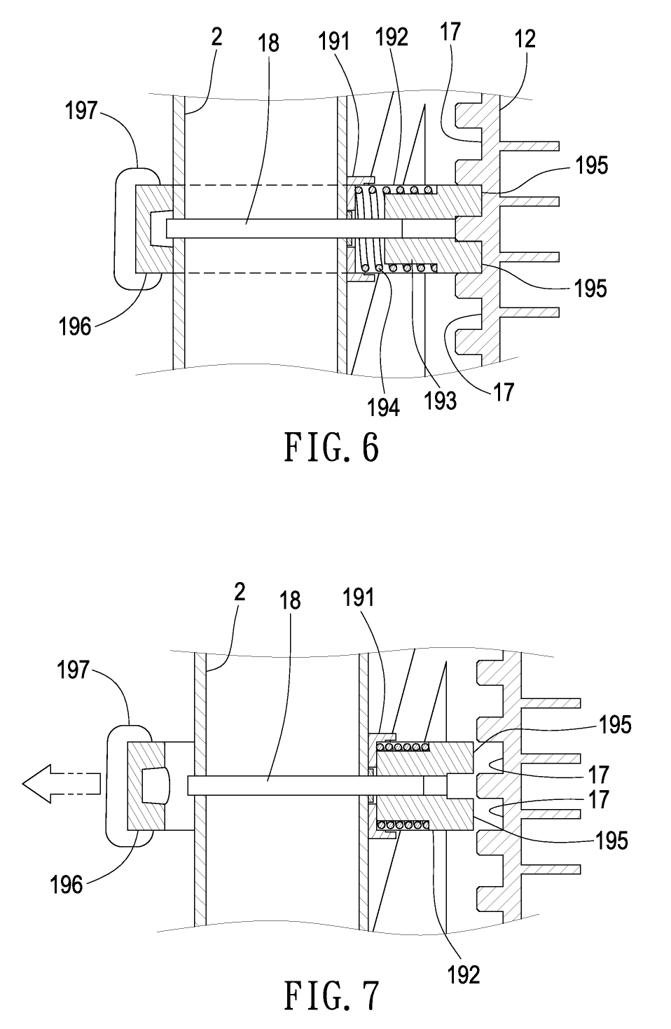

Referring to FIGS. 2-6, a saddle adjusting device 1 in accordance with the present invention is engaged on an inclined seat tube 2 and provided with a saddle 3 on a top end thereof. The saddle adjusting device 1 in accordance with the present invention comprises a seat body 10 which is made up of two symmetrical oppositely-connected shells 11, 12. The seat body 10 is formed with a support portion 13 on a top end thereof for placement of the saddle 3.

The seat body 10 includes a through portion 14 for insertion of the seat tube 2. Since the seat body 10 is made up of the shells 11, 12, the through portion 14 is formed between the two shells 11, 12. The seat body 10 is provided with two spaced seat tube clamps 15 along the through portion 14, and the seat tube clamps 15 are used to clamp the seat body 10 on the seat tube 2.

The seat body 10 includes a penetrating portion 101 corresponding to each of the seat tube clamps 15 and is provided with two half rings 111, 121 at each of the penetrating portions 101 to form a part of the through portion 14. Each of the seat tube clamps 15 includes two semi-circular pivotally connected fastening members 151, 152. One end of one of the two fastening members 151, 152 is pivotally connected to one end of the other of the two fastening members 151, 152 by a pin 153, and a shaft 153 is inserted through the other ends of both the two fastening members 151, 152. One end of the shaft 153 is eccentrically pivotally connected with a handle 155 in such a manner that the handle 155 can be pivoted to tighten the two fastening members 151, 152 to force the two half rings 111, 121 to clamp the seat tube 2 or loosen the two fastening members 151, 152 to make the two half rings 111, 121 unclamp the seat tube 2.

The structure of the seat tube clamp 15 is not the feature of the present invention, so no further description is provided herein.

The seat body 10 is provided with two ears 102 at both sides of each of the penetrating portions 101 correspondingly to the pin 153 of the seat tube clamps 15, and each of the ears 102 is defined with an engaging hole 103 for engagement with the corresponding pin 153 to position the respective seat tube clamps 15.

The seat body 10 is provided in a middle portion of the through portion 14 with a hollow portion 16 which laterally penetrates the seat body 10. The hollow portion 16 is also formed between the two shells 11, 12. Further, the hollow portion 16 is defined at one side thereof with plural engaging grooves 17 along the seat tube 2. The respective engaging grooves 17 are open vertically to the axial direction of the seat tube 2, and the respective engaging grooves 17 are as long as the diameter of the seat tube 2.

The seat tube 2 is fixedly provided with a bolt 18 at a predetermined position and engaged with an engaging assembly 19 for cooperating with the bolt 18. One end of the bolt 18, which is located adjacent to the engaging grooves 17, protrudes out of the seat tube 2 a predetermined length, and this end of the bolt 18 is provided with a base 191 which is semi-circular in cross section. The base 191 is provided with a sliding seat 192. The sliding seat 192 includes a cylinder portion 193 for insertion of the bolt 18. Between the base 191 and the sliding seat 192 is mounted a spring 194 in such a manner that the sliding seat 192 can slide along the bolt 18 and the base 191. The sliding seat 192 is formed with two protruding portions 195 at one side thereof adjacent to the respective engaging grooves 17 in such a manner that the protruding portions 195 can be engaged into the engaging grooves 17. Two ends at the other side of the sliding seat 192 are connected by a connecting seat 196, so that the sliding seat 192 of the engaging assembly 19 can move along the bolt 18 and the base 191 in the direction vertical to the axial direction of the seat tube 2 and can be positioned on the seat tube 2 to make the two protruding portions 195 engage into or disengage from the respective engaging grooves 17. In addition, the connecting seat 196 is provided with an outwards-protruding operating portion 197 which protrudes out of the hollow portion 16, so that it is convenient for the user to operate the connecting seat 196 and the sliding seat 192.

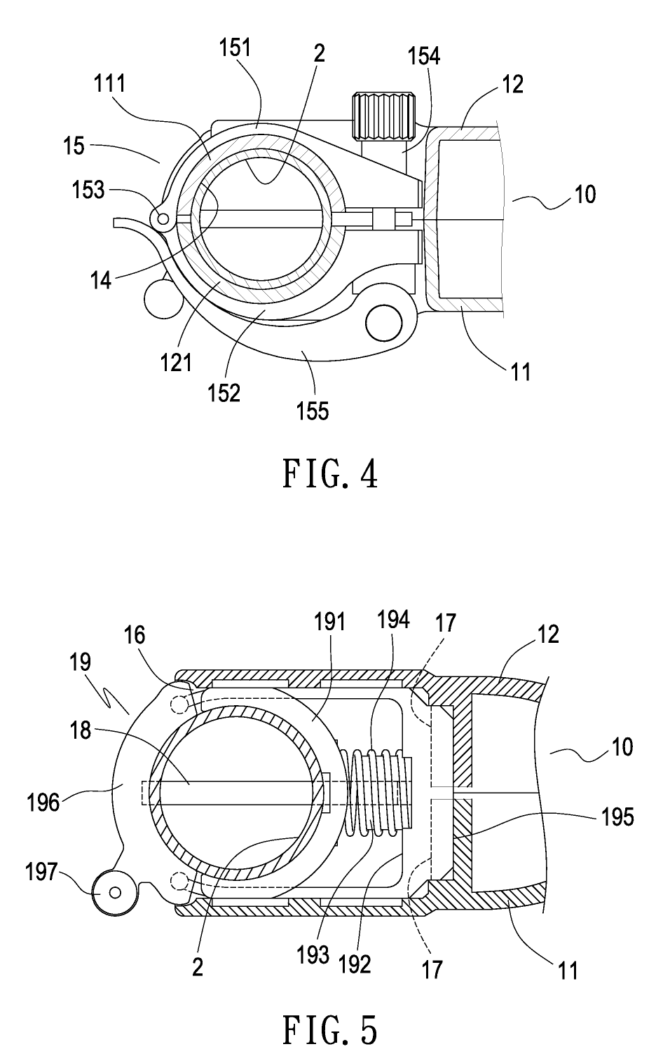

When the height of the saddle 3 needs adjusting, the handles 155 of the two seat tube clamps 15 will be released first to loosen the seat body 10 from the seat tube 2, and then the engaging assembly 19 will be operated in such a manner that the user can grip the operating portion 197 to pull the connecting seat 196 and the sliding seat 192 outwards, as shown in FIG. 7, at this moment, the protruding portions 195 of the sliding seat 192 will disengage from the engaging grooves 17, so that the user can move the seat body 10 along the seat tube 2 to a desired position, and subsequently, the user will release the operating portion 197, so that the engaging assembly 19 can push the connecting seat 196 and the sliding seat 192 backwards by means of the elastic force of the spring 194 to make the two protruding portions 195 engage into the engaging grooves 17 so as to position the seat body 10 assuredly, and finally, the handles 155 of the respective seat tube clamps 15 will be rotated to force the half rings 111, 121 to clamp the seat tube (as shown in FIG. 4) to fix the seat body 10 on the seat tube 2.

The contact area between the respective engaging grooves 17 and the protruding portions 195 are relatively larger, and the engaging assembly 19 is engaged into the engaging grooves 17 by two protruding portions 195, so that the contact area between the engaging assembly 19 and the seat body 10 is enough to position the seat body 10 on the seat tube 2 effectively. Furthermore, the seat body 10 includes the penetrating portions 101 corresponding to the respective seat tube clamps 15, and at each of the penetrating portions 101 are provided two half rings 111, 121 which forms a part of the through portion 14 of the seat body 10, such that the seat tube clamps 15 can be used to force the two half rings 111, 121 to clamp the seat tube assuredly. By such arrangements, the saddle adjusting device in accordance with the present invention can use the two seat tube clamps 15 to cooperate with the engaging assembly 19 to position the seat body 10 on the seat tube 2 assuredly.

While we have shown and described various embodiments in accordance with the present invention, it is clear to those skilled in the art that further embodiments may be made without departing from the scope of the present invention.

What is claimed is:

1. A saddle adjusting device being slidably disposed on a seat tube and comprising a seat body, the seat body including a support portion on a top end thereof for placement of a saddle, the seat body being provided with a through portion for insertion of the seat tube, and at least one seat tube clamp along the through portion for clamping the seat body on the seat tube, the seat body being provided in a middle portion of the through portion with a hollow portion which laterally penetrates the seat body, the hollow portion being defined at one side thereof with plural engaging grooves along the seat tube, the seat tube being fixedly provided with a bolt and provided with an engaging assembly for cooperating with the bolt, the engaging assembly being allowed to move along the bolt in a direction vertical to an axial direction of the seat tube, the engaging assembly being formed with at least one protruding portion at one side thereof adjacent to the respective engaging grooves for engaging into the engaging grooves.

2. The saddle adjusting device as claimed in claim 1, wherein the seat body is made up of two symmetrical oppositely-connected shells.

3. The saddle adjusting device as claimed in claim 1, wherein the seat body is provided with two spaced seat tube clamps along the through portion.

4. The saddle adjusting device as claimed in claim 1, wherein the seat body includes a penetrating portion corresponding to the at least one seat tube clamp.

5. The saddle adjusting device as claimed in claim 3, wherein the seat body includes two penetrating portions corresponding to the respective seat tube clamps.

6. The saddle adjusting device as claimed in claim 1, wherein the seat tube clamp includes two semi-circular pivotally connected fastening members, and one end of one of the two fastening members is pivotally connected to one end of the other of the two fastening members by a pin, and a shaft is inserted through the other ends of both the two fastening members, one end of the shaft is eccentrically pivotally connected with a handle in such a manner that the handle is allowed to be pivoted to loosen or tighten the two fastening members.

7. The saddle adjusting device as claimed in claim 3, wherein the seat tube clamp includes two semi-circular pivotally connected fastening members, and one end of one of the two fastening members is pivotally connected to one end of the other of the two fastening members by a pin, and a shaft is inserted through the other ends of both the two fastening members, one end of the shaft is eccentrically pivotally connected with a handle in such a manner that the handle is allowed to be pivoted to loosen or tighten the two fastening members.

8. The saddle adjusting device as claimed in claim 6, wherein the seat body is provided with two ears at both sides of each of the penetrating portions correspondingly to the pin of the seat tube clamp and each of the ears is defined with an engaging hole for engagement with the corresponding pin.

9. The saddle adjusting device as claimed in claim 7, wherein the seat body is provided with two ears at both sides of each of the penetrating portions correspondingly to the pin of the seat tube clamp and each of the ears is defined with an engaging hole for engagement with the corresponding pin.

10. The saddle adjusting device as claimed in claim 1, wherein one end of the bolt, which is located adjacent to the engaging grooves, protrudes out of the seat tube a predetermined length for cooperating with the engaging assembly.

11. The saddle adjusting device as claimed in claim 1, wherein the engaging assembly is formed with two protruding portions at one side thereof adjacent to the respective engaging grooves.

12. The saddle adjusting device as claimed in claim 1, wherein the respective engaging grooves are open in a direction vertical to the axial direction of the seat tube, and the respective engaging grooves are as long as a diameter of the seat tube.

13. The saddle adjusting device as claimed in claim 1, wherein the engaging assembly is provided with a base at one end of the bolt which protrudes out of the seat tube, the base is semi-circular in cross section and provided with a sliding seat, the at least one protruding portion is formed at one side of the sliding seat adjacent to the respective engaging grooves, the sliding seat includes a cylinder portion for insertion of the bolt, between the base and the sliding seat is mounted a spring, two ends at the other side of the sliding seat are connected by a connecting seat, so that the sliding seat is allowed to move along the bolt and the base in a direction vertical to the axial direction of the seat tube and allow to be positioned on the seat tube to make the two protruding portions engage into or disengage from the respective engaging grooves.

14. The saddle adjusting device as claimed in claim 13, wherein the connecting seat includes an outwards-protruding operating portion which protrudes out of the hollow portion, so that it is convenient for the user to operate the connecting seat and the sliding seat.
